(19) United States
(12) Patent Application Publication
(10) Pub. No.: US 2022/0207074 A1
(43) Pub. Date: Jun. 30, 2022

(54) SYSTEM AND METHOD FOR THE PROVISION OF CONTENT-DEPENDENT LOCATION INFORMATION

(71) Applicant: ARRIS ENTERPRISE LLC, Suwanee, GA (US)

(72) Inventors: Vishwanath Kalalbandi, Shivanand Nagar (IN); Sunil Kumar Puttaswamy Gowda, Bangalore (IN)

(73) Assignee: ARRIS ENTERPRISE LLC, Suwanee, GA (US)

(21) Appl. No.: 17/523,528

(22) Filed: Nov. 10, 2021

Related U.S. Application Data
(60) Provisional application No. 63/132,191, filed on Dec. 30, 2020.

(51) Int. Cl. G06F 16/487; G06K 9/00; G06F 16/29

(52) U.S. Cl. CPC G06F 16/487; G06F 16/29; G06K 9/00711

(57) ABSTRACT

A system and method for providing content-dependent location information based upon video frame information. In response to ta user command, video frame data is captured from content being viewed and analyzed with respect to location information database. The analysis ideally leverages artificial intelligence and/or machine learning processes and returns a graphical improved content casting audio management. The content-dependent location information is provided to a requesting user graphically and or audibly.

### CROSS-REFERENCE TO RELATED APPLICATION

This application claims the benefit of U.S. Provisional Patent Application No. 63/132,191, filed Dec. 30, 2020, which is incorporated by reference herein in its entirety.

### BACKGROUND OF THE INVENTION

The increased provision of broadband services in residential settings has greatly changed the manner in which the viewing public consume video content. The advent of video-on-demand services, increased streaming options and proliferation of on-line commerce have all contributed to an environment wherein the consumption of video has gone from a passive activity to one in which viewers see themselves as active participants in or even directors of the video experience.

Content providers, such as multiple system operators (“MSOs”), have responded to (or perhaps driven) this shift in the mindset of the video consumer by offering increased interactive services, including on-line commerce offerings tied to program offerings wherein certain products shown in a given entertainment program could be selected by a viewer for purchase. Such a purchase could be completed “on-screen” utilizing a graphical user interface, either during the video program or at a later time. Although this type of in-program shopping offers a novel avenue for commerce, it can be regarded negatively by the viewing public, much in the way that blatant product-placement in television and movies has been. Also, such on-screen product purchase opportunities require a significant amount of pre-processing of the associated video programing to properly tag a given object and embed associated product information.

It would be advantageous to provide interactive or on-demand functionality to video consumers in a less intrusive and obvious manner, enabling viewers to make a general inquiry related to the content being consumed, rather than providing a directed experience tied to particular, pre-tagged items within certain video content. It would also be beneficial if such functionality could be supported without the need for significant pre-processing of video content, thereby reducing or eliminating the associated burden and/or costs that would likely be borne by a content provider or MSO.

### BRIEF SUMMARY OF THE INVENTION

A system and method for providing content-dependent location information based upon video frame information. In response to a user command, video frame data is captured from content being viewed and analyzed with respect to location information database. The analysis ideally leverages artificial intelligence and/or machine learning processes and returns a graphical improved content casting audio management. The content-dependent location information is provided to a requesting user graphically and or audibly.

### BRIEF DESCRIPTION OF THE DRAWINGS

The aspects, and advantages of the present invention will become better understood with regard to the following description, appended claims, and accompanying drawings in which:

FIG. 1 provides a diagram of a system adapted for the provision content-dependent location information to a requesting user.

FIG. 2 is a flow diagram of a first process supported by the system of FIG. 1.

FIG. 3 is a depiction of a first display screen associated with system of FIG. 1.

FIG. 4 is a depiction of a second display screen associated with system of FIG. 1.

FIG. 5 is a depiction of a third display screen associated with system of FIG. 1.

FIG. 6 is a depiction of a fourth display screen associated with system of FIG. 1.

FIG. 7 is a depiction of a fifth display screen associated with system of FIG. 1.

### DETAILED DESCRIPTION

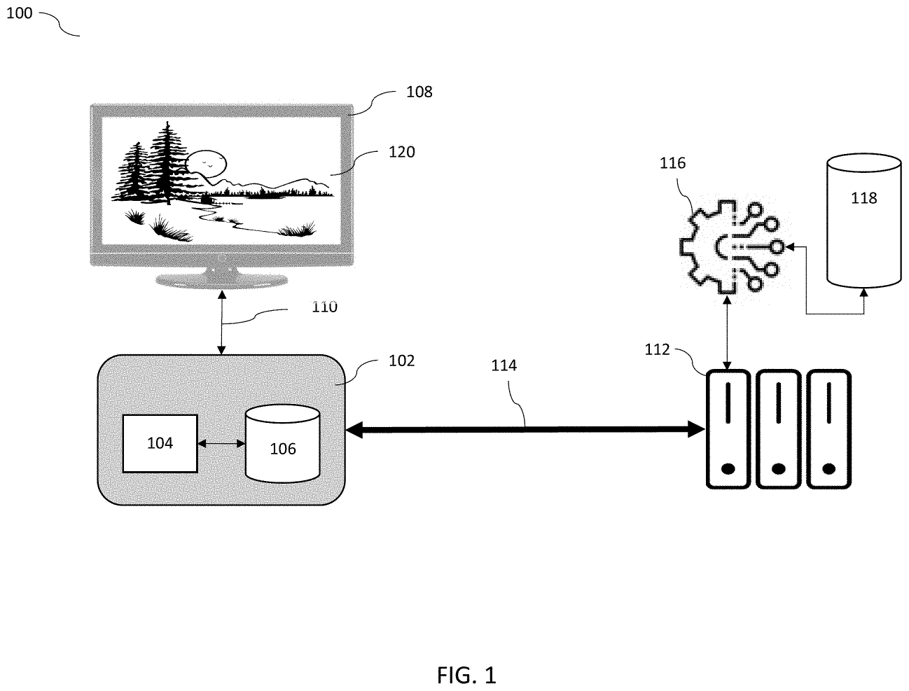

FIG. 1 is a functional diagram of a first preferred embodiment of a system (100) adapted to support the provision content-dependent location information to a requesting user. As shown, the system comprises smartphone media gateway appliance (“MGA”) 102 (such as a set-top box), which includes processor 104 and memory 106. MGA 102 is connected to digital television (“DTV”) 108 by local network 110, and to MSO headend 112 by broadband network 114. MSO headend is linked to image analysis engine 116 and location information database 118.

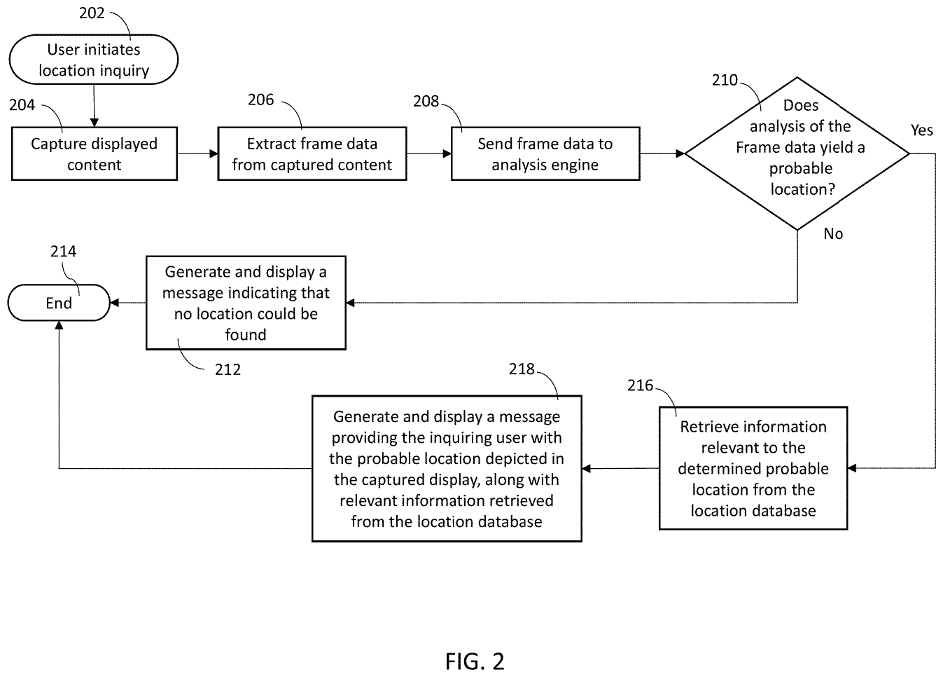

Processor 104 is adapted to utilize information stored in memory 106 to respond to user commands received at MGA 102. These commands can originate from a pointing device or remote-control device associated with DTV 108, or from some other peripheral, such as a smartphone or tablet, in communication with MGA 102. In particular, Processor 104 is adapted to utilize information in memory 106 to respond to a user initiating a location request related to the images being viewed on DTV 108. For example, assume a user is viewing video content provided by the MSO headend or from an over-the-top content provider showing a particular location or setting (120). Seeing this, the user becomes curious to learn more about the location in which the video content is set and depresses one or more buttons upon a remote-control device to initiate a location inquiry (see step 202 of FIG. 2).

Upon receiving the inquiry initiation, processor 104 captures the data representing the content being displayed upon DTV 108 and stores it in memory 106 (step 204 of FIG. 2). Processor 104 then extracts data representing one or video frames from the captured content data (step 206). This frame data is then sent to analysis engine 116 via broadband network 114 and MSO 112 (step 208). Analysis engine 116 could be any type of processor or processors adapted to analyze video frame information and compare it with a database of location image data (118). This analysis and comparison would ideally utilize artificial intelligence/machine learning (“AI/ML”) algorithms, such as those associated with convolutional neural networks. These AI/ML algorithms would preferably have been arrived at based upon information associated with a large database of location images. The utilization of AI/ML algorithms and techniques for the analysis and recognition of video frame images id well-known in the art and will not be discussed in further detail here.

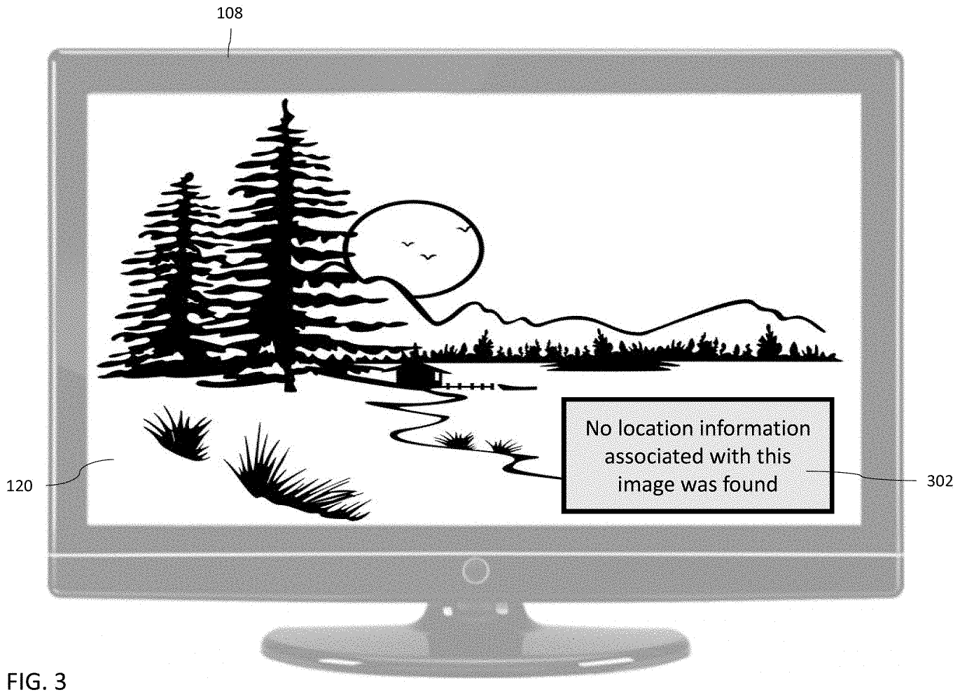

If the AI/ML analysis fails to yield a probable location associated with the image(s) defined by the frame data, analysis engine 116 returns a message indicative of such to MGA 102 via MSO headend 112 and broadband network 114, and the location inquiry process terminates. This is depicted in FIG. 2 as a negative result of step 210, followed by steps 212 and 214. An example of such a message is depicted in FIG. 3. As shown, the failure message (302) is presented as an overlay upon content 120.

However, if the AI/ML analysis finds a probable match for the locale depicted by the video frame data, analysis engine 116 queries location information database 118 for relevant information associated with the identified location. This relevant information could be defined by the MSO or other authority responsible for the operation of analysis engine 114, or defined by a profile associated with the inquiring user that was stored in memory 106 or other database(s) maintained an MSO or content provider. Such relevant location information could include one or more of: location name; geographical coordinates; city, county, state and country information; time; temperature; weather forecast; travel restrictions; demographic information; lodging information; attractions; distance from inquiring party location; travel options and pricing from the inquiring party's location, etc.

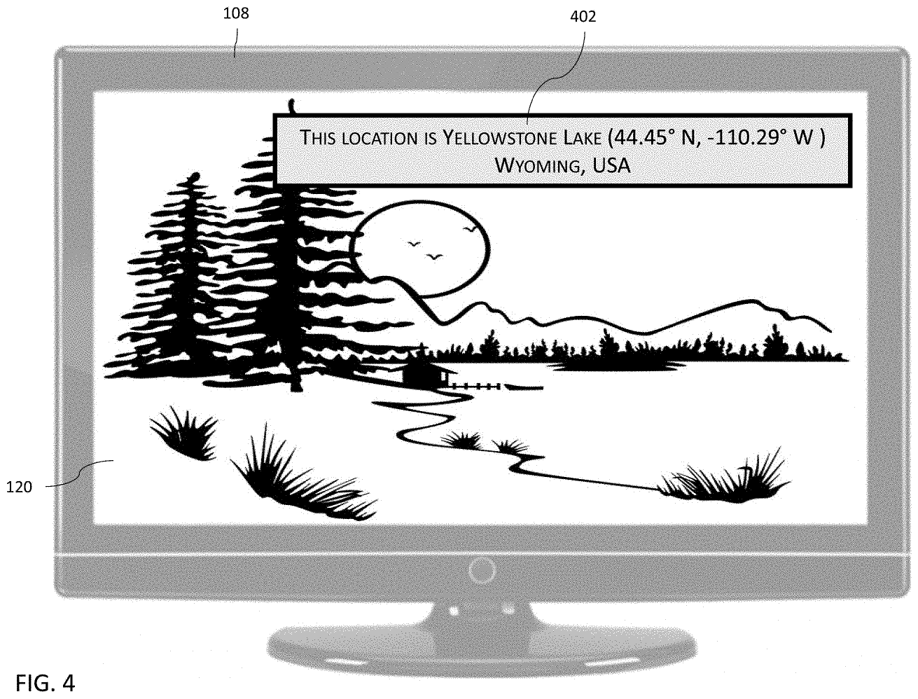

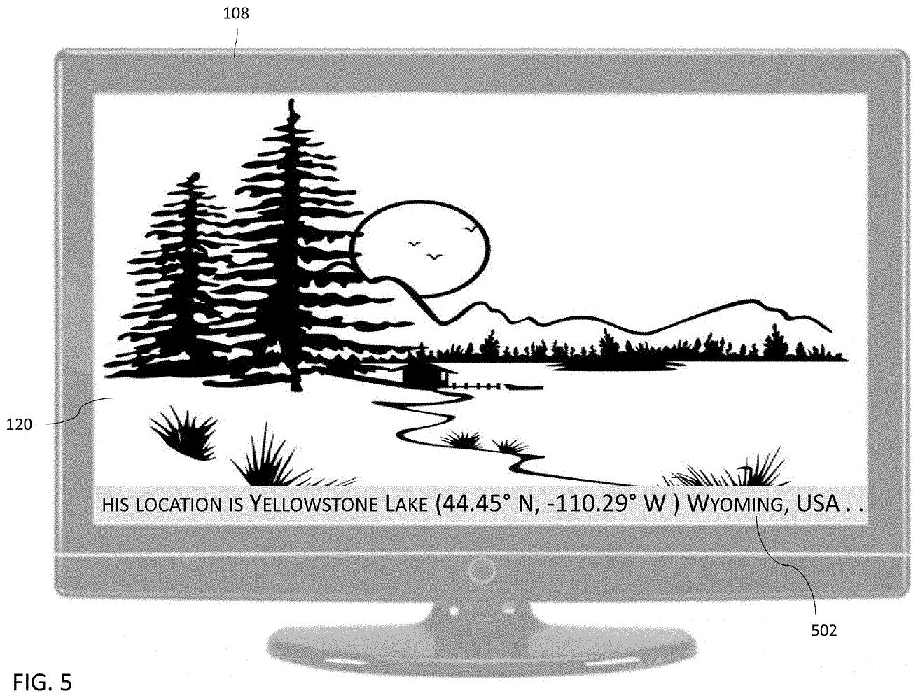

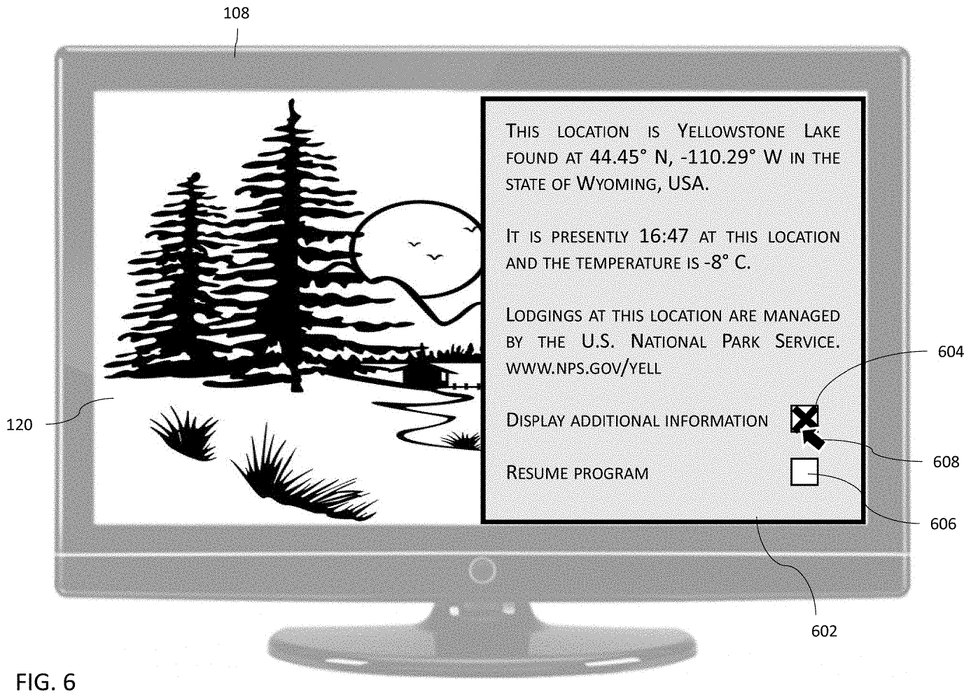

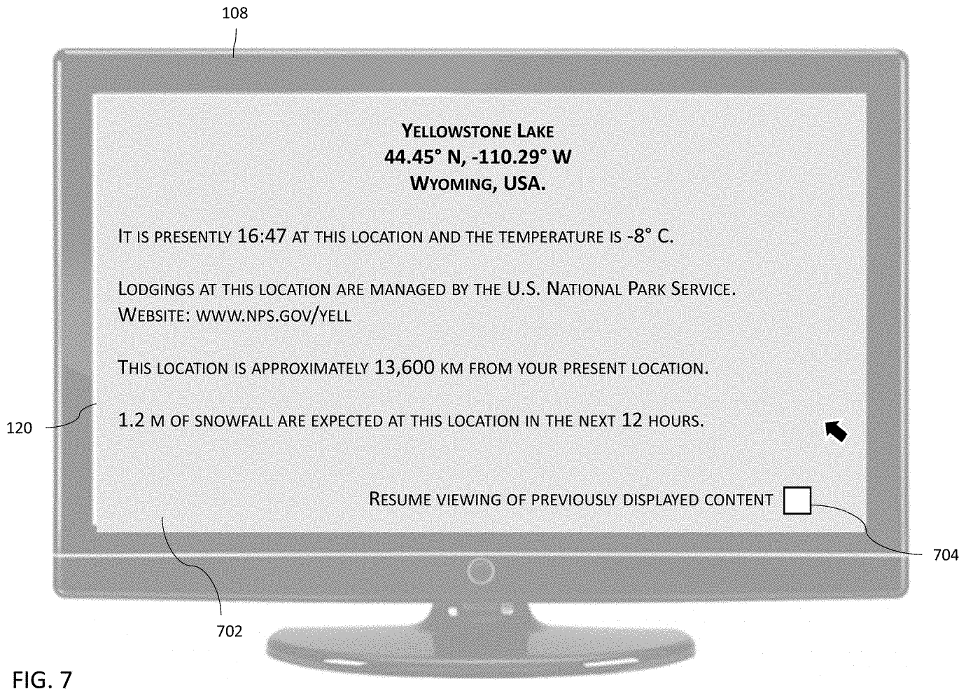

The relevant location information is retrieved from location information database 118 by analysis engine 116 (see step 216 of FIG. 2). The retrieved information is then sent, via headend 112 and broadband network 114, to MGA 102. Upon receipt, processor 104 generates and displays a message upon DTV 108 informing the inquiring user of the retrieved location information. FIG. 4 provides a depiction of location information presented as an overlay (402) upon content 120. The location information could also be presented as a crawler running along the top or bottom of the content (see element 502 of FIG. 5), or presented as a split screen (see element 602 of FIG. 6). As shown in FIG. 6, the displayed information can also include user command options to view additional information (604) or return to the full-screen viewing of content (606). A user would select these options by manipulating an on-screen cursor (608). This additional information could be presented as a full-screen representation by processor 104 (see screen 702 of FIG. 7). During a full-screen presentation of the location information, the content that was being viewed (120) could be paused by processor 120 until the user indicated a desire resume watching it (element 704).

Although the invention herein has been described with reference to particular embodiments, it is to be understood that these embodiments are merely illustrative of the principles and applications of the present invention. For example, the functionality of the wired networks and links depicted herein could be supported by wireless networks. Similarly, the device utilized as the viewing and user interface for the viewing of content and location information could be any one of a host of well-known devices supporting the display of video content and information, including smartphones, tablets, computing systems, and digital assistants. It will also be understood that all or part of the above-described processing and storage associated with MGA 102 could be performed in whole or in-part by an offsite server or processing means linked to these devices by a wired or wireless network. Furthermore, the functionality associated with the MSO headend in the above disclosed embodiments could also be provided by a remote server or other distant processing means linked to the MGA via public or private broadband network. The disclosed system and method could also be modified to support the generation of an audible response to a requesting user's request for location information, wherein a synthesized voice or pre-recorded recitation of location information is provided to a user via an audio system associated with an MGA or a requesting device. This audio could be provided as a supplement to or in lieu of the graphical location information. All of the above variations and reasonable extensions therefrom could be implemented and practiced without departing from the spirit and scope of the present invention as defined by the appended claims.

1. A system for providing content-dependent location information; comprising:
at least one memory adapted to store location image data;
at least one memory adapted to store location information; and
at least one processor adapted to:
receive a user request for location information comprising video frame data;
compare received video frame data to the stored location image data; and
retrieve location information based, at least in part, upon a comparison of the video frame data to the stored location image information.

2. The system of claim 1 wherein the location information comprises at least one of the following:
a location name;
geographical coordinates of a location;
the name of a city;
the name of a county
the name of a province;
the name of a state;
the name of a country;
the present time at a location;
location temperature;
location weather forecast;
location travel restrictions;
location demographic information;
location lodging information;
location tourist attractions;
the distance between the user and a location; and
travel options to a location.

3. The system of claim 1 further comprising at least one media gateway device adapted to:
receive at least one user command comprising the at least one user request; and
communicate the at least one user request to the at least one processor.

4. The system of claim 1 wherein the at least one processer comprises at least one of the following:
a headend; and
a server.

5. The system of claim 1 wherein the at least one processor is remotely located from the at least one display.

6. The system of claim 1 further comprising at least one display adapted to display video content.

7. The system of claim 6 wherein the at least one display comprises at least one of the following:
a digital television;
a smartphone;
a tablet;
a computer; and
a digital assistant.

8. The system of claim 6 the video frame data is data extracted from video content being viewed upon the at least one display.

9. The system of claim 6 wherein the at least one processor is further adapted to generate a representation of the retrieved location information, wherein the representation comprises at least one of the following:
a graphical representation; and
an audible representation.

10. system of claim 9 wherein the graphical representation comprises at least one of the following:
an overlay upon the content being viewed;
a crawler upon the video content being viewed;
a split-screen adjacent to the video content being viewed; and
a full-screen display upon the at least one video display.

11. A method for providing content-dependent location information, a system comprising:
at least one memory adapted to store location image data; and
at least one memory adapted to store location information;
the method comprising the steps of:
receiving a user request for location information comprising video frame data;
comparing received video frame data to the stored location image data; and
retrieving location information based, at least in part, upon a comparison of the video frame data to the stored location image information.

12. The method of claim 11 wherein the location information comprises at least one of the following:
a location name;
geographical coordinates of a location;
the name of a city;
the name of a county
the name of a province;
the name of a state;
the name of a country;
the present time at a location;
location temperature;
location weather forecast;
location travel restrictions;
location demographic information;
location lodging information;
location tourist attractions;
the distance between the user and a location; and
travel options to a location.

13. The method of claim 11 wherein the system further comprises at least one media gateway, and the method further comprised the step of:
receiving at the at least one media gateway device least one user command comprising the at least one user request.

14. The method of claim 11 the video frame data is data extracted from video content being viewed by the user initiating the user request for location information.

15. The method of claim 11 wherein the system further comprises the step of:
generating a representation of the retrieved location information, wherein the representation comprises at least one of the following:
a graphical representation; and
an audible representation.

16. system of claim 15 wherein the graphical representation comprises at least one of the following:
an overlay upon the video content;
a crawler upon video content;
a split-screen adjacent to video content; and
a full-screen display.
